(19) United States
(12) Patent Application Publication
(10) Pub. No.: US 2025/0225029 A1
(43) Pub. Date: Jul. 10, 2025

(54) MEMORY DEVICE DECODING USING RELIABILITY VALUES

(71) Applicant: Micron Technology, Inc., Boise, ID (US)

(72) Inventors: Mustafa N. Kaynak, San Diego, CA (US); Patrick R. Khayat, San Diego, CA (US); Sivagnanam Parthasarathy, Carlsbad, CA (US)

(21) Appl. No.: 19/011,010

(22) Filed: Jan. 6, 2025

Related U.S. Application Data
(60) Provisional application No. 63/618,551, filed on Jan. 8, 2024.

(51) Int. Cl. G06F 11/10

(52) U.S. Cl. CPC G06F 11/1068; G06F 11/1004; G06F 11/1016

(57) ABSTRACT

Methods, systems, and apparatuses include detecting a failure to decode a first codeword, the first codeword including user data and first level parity data for the user data. A second codeword is read in response to the detected failure, the second codeword including second level parity data for the user data. A first set of one or more reliability values is selected for the second level parity data, the first set of reliability values differing from a second set of reliability values for the user data and the first level parity data. The user data is decoded using the first level parity data, the second level parity data, the selected first set of reliability values, and the second set of reliability values.

### CROSS-REFERENCE TO RELATED APPLICATION

The present application claims the benefit of U.S. Provisional Patent Application No. 63/618,551 filed on Jan. 8, 2024, which is incorporated by reference herein in its entirety.

### TECHNICAL FIELD

The present disclosure generally relates to memory device decoding, and more specifically, relates to memory device error correction using reliability values.

### BACKGROUND ART

A memory subsystem can include one or more memory devices that store data. The memory devices can be, for example, non-volatile memory devices and volatile memory devices. In general, a host system can utilize a memory subsystem to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a memory subsystem in accordance with some embodiments of the present disclosure.

FIG. 2 illustrates an example computing system that includes a user data decoding component in accordance with some embodiments of the present disclosure.

FIG. 3 is a flow diagram of an example method to decode user data using reliability values in accordance with some embodiments of the present disclosure.

FIG. 4 is another flow diagram of an example method to decode user data using reliability values in accordance with some embodiments of the present disclosure.

FIG. 5 is a block diagram of an example computer system in which embodiments of the present disclosure may operate.

### DETAILED DESCRIPTION

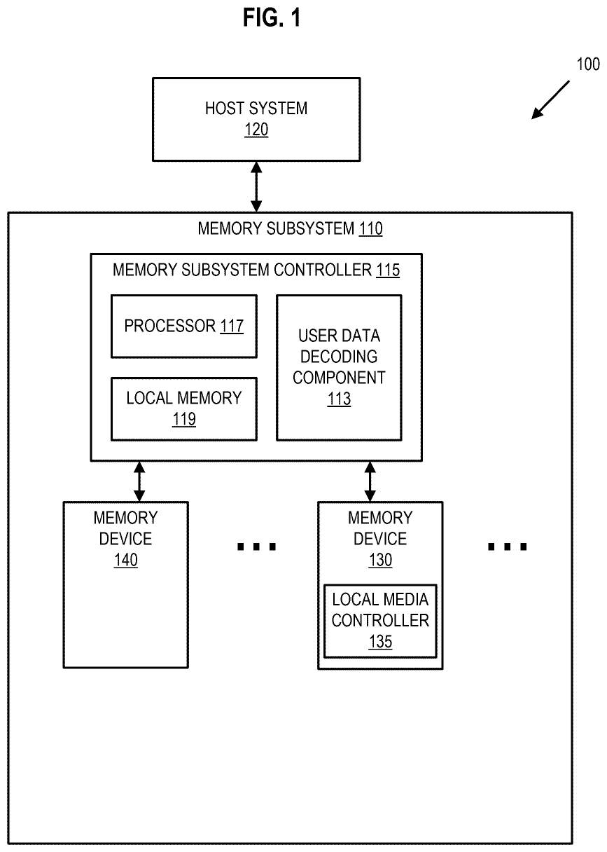

Aspects of the present disclosure are directed to decoding user data using reliability values in a memory subsystem. A memory subsystem can be a storage device, a memory module, or a hybrid of a storage device and memory module. Examples of storage devices and memory modules are described below in conjunction with FIG. 1. In general, a host system can utilize a memory subsystem that includes one or more components, such as memory devices that store data. The host system can provide data to be stored at the memory subsystem and can request data to be retrieved from the memory subsystem.

A memory device can be a non-volatile memory device. A non-volatile memory device is a package of one or more dice. One example of non-volatile memory devices is a negative-and (NAND) memory device. Other examples of non-volatile memory devices are described below in conjunction with FIG. 1. The dice in the packages can be assigned to one or more channels for communicating with a memory subsystem controller. Each die can consist of one or more planes. Planes can be grouped into logic units identified by a logical unit number (LUN). For some types of non-volatile memory devices (e.g., NAND memory devices), each plane consists of a set of physical blocks, which are groups of memory cells to store data. A cell is an electronic circuit that stores information.

Depending on the cell type, a cell can store one or more bits of binary information, and has various logic states that correlate to the number of bits being stored. The logic states can be represented by binary values, such as “0” and “1”, or combinations of such values. There are various types of cells, such as single-level cells (SLCs), multi-level cells (MLCs), triple-level cells (TLCs), quad-level cells (QLCs), and penta-level cells (PLCs). For example, an SLC can store one bit of information and has two logic states while a QLC can store four bits of information and has sixteen logic states.

In conventional memory systems, user data is stored with error correcting code parity data to ensure the reliability of the user data. For example, a memory system uses a low-density parity check algorithm (e.g., an LDPC encoder) to generate an LDPC codeword for the user data. The memory system can then decode the codeword (e.g., using an LDPC decoder), correcting any errors in the user data using the parity data of the codeword. These memory systems can use log-likelihood ratios (LLRs) in the LDPC decoders to provide information about the reliability of each bit in the received codeword. For example, some portions of memory undergo more stress (e.g., higher temperatures or repeated memory operations) than others and/or are subject to manufacturing defects and inconsistencies.

The LLRs are calculated based on the received signal and the channel model and represent the reliability for the stored data. The magnitude of a given LLR represents the reliability information for the corresponding data with higher magnitudes indicating a higher reliability for that data. The sign of a given LLR (e.g., whether the LLR is positive or negative) represents the state of the data (e.g., whether a bit is likely to be a 0 or a 1). The memory system uses the LLRs to make decisions about which bits are most likely to be in error. For example, the memory system calculates the LLRs for each bit in the received codeword and then iteratively updates the LLRs based on the parity check constraints. At each iteration, the memory system makes decisions about which bits are most likely to be in error. The decoding process continues until the decoder converges to a solution, or until a maximum number of iterations is reached. For example, the decoding process continues until there are no remaining parity violations. Memory systems can use LLRs in LDPC decoders in a number of different ways. For example, the decoder can use the LLRs to determine the order in which to update the bits in the codeword, calculate the probability that a bit is in error, estimate the channel noise level, and/or adapt the decoding algorithm to the channel conditions.

Memory systems, however, can still fail to decode the codeword even with LLR, e.g., reliability information. For example, a memory system's ability to correct bit errors is limited by the number of parity bits used in the codeword. When decoding fails, more advanced methods of error correction can be employed. For example, the memory system can use a different decoding algorithm or, if available, additional parity bits. The memory subsystem that uses multiple levels of parity data, such as a first level of parity data (e.g., codeword described above) and a second level of parity data (the additional parity bits), typically stores the second level of parity data in a different memory location than the codeword. In the event of a decode failure using the first level of parity data, the memory system can use the second level parity data to attempt to decode the user data. Because the second level parity data is stored separately from the user data and the first level parity data, the second level parity data can have different reliability characteristics than the codeword. Using the same LLRs for the user data, first level parity data, and second level parity data when decoding is therefore suboptimal. This can result in incorrect decoding results and/or a failure to correct errors.

Aspects of the present disclosure address these and other deficiencies by selecting different reliability values (e.g., LLRs) for the second level parity data and the user data and first level parity data. For example, since the second level parity data is not used unless the decoding of the user data using the first level parity data has already failed, the user data and first level parity data are determined to be stored in a weak portion of memory. The reliability values selected for the second level parity data, therefore, might be higher (e.g., more reliable) than the reliability values for the user data and the first level parity data. As a result, the memory system uses more accurate information when decoding the user data, increasing the likelihood of correct decoding. Additionally, the memory system can freeze the second level parity data when the second level parity data is successfully decoded. For example, because the second level parity is stored in a separate codeword read by the memory subsystem, if the memory system successfully decodes the second level parity data, the memory system determines that the values for the second level parity data are correct and can assign a maximum reliability value and/or otherwise cause the bits in the second level parity data to be frozen to prevent them from being changed while decoding the user data codeword.

FIG. 1 illustrates an example computing system 100 that includes a memory subsystem 110 in accordance with some embodiments of the present disclosure. The memory subsystem 110 can include media, such as one or more volatile memory devices (e.g., memory device 140), one or more non-volatile memory devices (e.g., memory device 130), or a combination of such.

A memory subsystem 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory subsystems 110. In some embodiments, the host system 120 is coupled to different types of memory subsystems 110. FIG. 1 illustrates one example of a host system 120 coupled to one memory subsystem 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processing device such as a processor chipset and a software stack executed by the processor chipset. The processor chipset can include one or more cores, one or more caches, a memory controller (e.g., NVDIMM controller), and/or a storage protocol controller (e.g., a peripheral component interconnect express (PCIe) controller, a serial advanced technology attachment (SATA) controller). The host system 120 uses the memory subsystem 110, for example, to write data to the memory subsystem 110 and read data from the memory subsystem 110.

The host system 120 can be coupled to the memory subsystem 110 via a physical host interface. Examples of a physical host interface include, but are not limited to, a SATA interface, including a mini-SATA (mSATA) interface, a PCIe interface, including a mini PCIe (mPCIE) interface, a Non-Volatile Memory Express (NVMe) interface, a universal serial bus (USB) interface, an a Fibre Channel, Serial Attached SCSI (SAS), a Small Computer System Interface (SCSI), a double data rate (DDR) memory bus, a dual in-line memory module (DIMM) interface (e.g., DIMM socket interface that supports Double Data Rate (DDR)), an Advanced Host Controller (AHCI) interface, an Open NAND Flash Interface (ONFI) interface, a Double Data Rate (DDR) interface, a Low Power Double Data Rate (LPDDR) interface, any other interface, and/or combinations of these interfaces. The physical host interface can be used to transmit data between the host system 120 and the memory subsystem 110. The host system 120 can further utilize an NVMe interface to access components (e.g., memory devices 130 and 140) when the memory subsystem 110 is coupled with the host system 120 by the PCIe interface. The physical host interface can provide an interface for passing control, address, data, and other signals between the memory subsystem 110 and the host system 120. FIG. 1 illustrates a memory subsystem 110 as an example. In general, the host system 120 can access multiple memory subsystems via the same communication connection, multiple separate communication connections, and/or a combination of communication connections.

The memory devices 130 and 140 can include any combination of the different types of non-volatile memory devices and/or volatile memory devices. The volatile memory devices (e.g., memory device 140) can be, but are not limited to, random-access memory (RAM), such as dynamic random-access memory (DRAM), synchronous dynamic random-access memory (SDRAM), video random-access memory (VRAM), and cache memory.

Some examples of non-volatile memory devices (e.g., memory device 130) include negative-and (NAND) type flash memory devices and write-in-place type memory devices, such as a three-dimensional cross-point (“3D cross-point”) memory device, which is a cross-point array of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory can perform a write-in-place operation, where a non-volatile memory cell can be programmed without the non-volatile memory cell being previously erased. NAND type flash memory includes, for example, two-dimensional NAND (2D NAND) and three-dimensional NAND (3D NAND).

Although non-volatile memory devices such as NAND type memory (e.g., 2D NAND, 3D NAND) and 3D cross-point array of non-volatile memory cells are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random-access memory (FeRAM), magneto random-access memory (MRAM), Spin Transfer Torque (STT)-MRAM, nano-RAM (NRAM), silicon-oxide-nitride-oxide-silicon (SONOS) memory, conductive bridging RAM (CBRAM), resistive random-access memory (RRAM), oxide based RRAM (OxRAM), negative-or (NOR) flash memory, and erasable programmable read-only memory (EPROM), including electrically erasable programmable read-only memory (EEPROM).

A memory subsystem controller 115 (or controller 115 for simplicity) can communicate with the memory devices 130 to perform operations such as reading data, writing data, or erasing data at the memory devices 130 and other such operations (e.g., in response to commands scheduled on a command bus by controller 115). The memory subsystem controller 115 can include hardware such as one or more integrated circuits and/or discrete components, a buffer memory, or a combination thereof. The hardware can include digital circuitry with dedicated (i.e., hard-coded) logic to perform the operations described herein. The buffer memory of subsystem controller 115 can include any of the volatile or non-volatile memory types mentioned above including combinations thereof. The memory subsystem controller 115 can be a microcontroller, special purpose logic circuitry (e.g., a field programmable gate array (FPGA), an application specific integrated circuit (ASIC), etc.), or another suitable processor.

The memory subsystem controller 115 can include a processing device 117 (processor) configured to execute instructions stored in memory subsystem 110 (e.g., stored in a local memory 119). In some examples, the local memory 119 of the memory subsystem controller 115 includes an embedded memory configured to store instructions for performing various processes, operations, logic flows, and routines that control operation of the memory subsystem 110, including handling communications between the memory subsystem 110 and the host system 120.

In some embodiments, the local memory 119 can include memory registers storing memory pointers, fetched data, etc. The local memory 119 can also include read-only memory (ROM) for storing micro-code. While the example memory subsystem 110 in FIG. 1 has been illustrated as including the memory subsystem controller 115, in another embodiment of the present disclosure, a memory subsystem 110 does not include a memory subsystem controller 115, and can instead rely upon external control (e.g., provided by an external host, or by a processing device or controller separate from the memory subsystem 110).

In general, the memory subsystem controller 115 can receive commands or operations from the host system 120 and can convert the commands or operations into instructions or appropriate commands to achieve the desired access to the memory devices (e.g., memory devices 130 and/or 140. The memory subsystem controller 115 can be responsible for other operations such as wear leveling operations, garbage collection operations, error detection and error-correcting code (ECC) operations, encryption operations, caching operations, and address translations between a logical address (e.g., logical block address (LBA) and/or namespace) and a physical address (e.g., physical block address) that are associated with the memory devices (e.g., memory devices 130 and/or 140). The memory subsystem controller 115 can further include host interface circuitry to communicate with the host system 120 via the physical host interface. The host interface circuitry can convert the commands received from the host system into command instructions to access the memory devices (e.g., memory devices 130 and/or 140) as well as convert responses associated with the memory devices into information for the host system 120.

The memory subsystem 110 can also include additional circuitry or components that are not illustrated. In some embodiments, the memory subsystem 110 can include a cache or buffer (e.g., DRAM) and address circuitry (e.g., a row decoder and a column decoder) that can receive an address from the memory subsystem controller 115 and decode the address to access the memory devices (e.g., memory devices 130 and/or 140).

In some embodiments, the memory devices (e.g., memory devices 130 and/or 140) include local media controllers 135 that operate in conjunction with memory subsystem controller 115 to execute operations on one or more memory cells of the memory devices (e.g., memory devices 130 and/or 140). An external controller (e.g., memory subsystem controller 115) can externally manage the memory devices (e.g., perform media management operations on the memory devices 130 and/or 140). In some embodiments, a memory device (e.g., memory device 130) is a managed memory device, which is a raw memory device combined with a local controller (e.g., local controller 135) for media management within the same memory device package. An example of a managed memory device is a managed NAND (MNAND) device.

The memory subsystem 110 includes a user data decoding component 113 that decodes user data using reliability values. In some embodiments, the controller 115 includes at least a portion of the user data decoding component 113. For example, the controller 115 can include a processing device 117 configured to execute instructions stored in local memory 119 for performing the operations described herein. In some embodiments, a user data decoding component 113 is part of the host system 120, an application, or an operating system.

The user data decoding component 113 decodes the user data using reliability values determined based on where parity data used for decoding the user data is stored. Further details with regards to the operations of the user data decoding component 113 are described below.

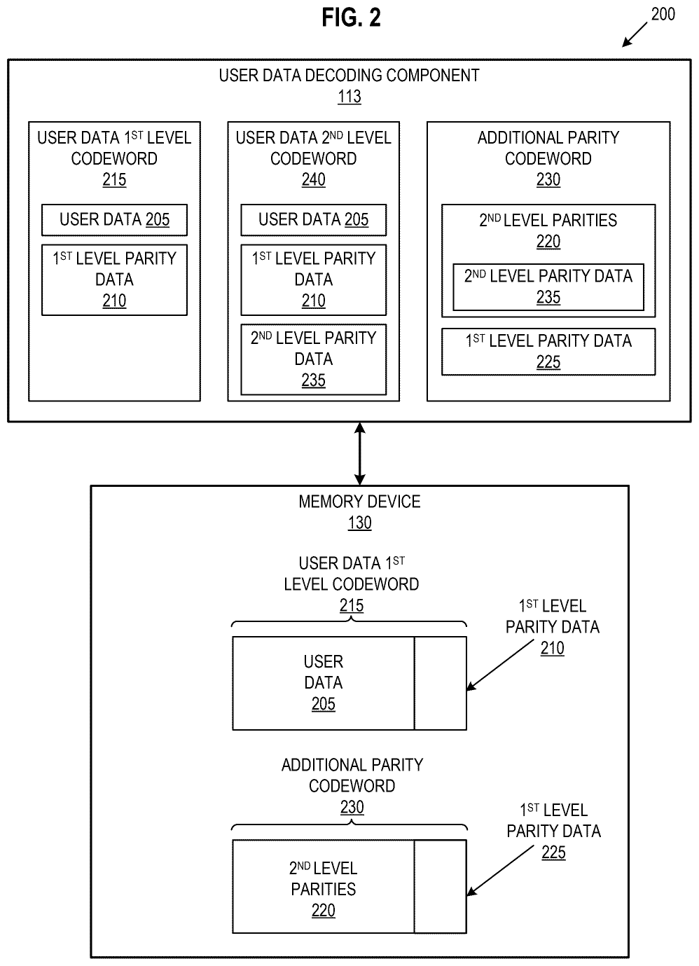

FIG. 2 illustrates an example computing system 200 that includes a user data decoding component 113 in accordance with some embodiments of the present disclosure. As shown in FIG. 2, memory device 130 includes user data first level codeword 215 and additional parity codeword 230. In the example illustrated in FIG. 2, user data first level codeword 215 might be stored in a portion of particular page type such as a lower page, an upper page, an extra page, and/or a top page in memory device 130. In some embodiments, a single page of memory device 130 includes multiple user data first level codewords. User data first level codeword 215 includes user data 205 and first level parity data 210 for user data 205. Additional parity codeword 230 includes second level parities 220 and first level parity data 225 for second level parities 220. For example, additional parity codeword 230 is created by encoding second level parities 220 which include second level parity data for each of the user data stored in the different pages (e.g., lower page, upper page, extra page, and/or top page). User data decoding component 113 generates second level parity data (e.g., second level parity data 235) for each of the different pages (e.g., lower page, upper page, extra page, and/or top page). User data decoding component 113 then groups this second level parity data to create second level parities 220. Second level parities 220 are encoded with first level parity data 225 to create additional parity codeword 230. In some embodiments, first level codeword 215 and additional parity codeword 230 are stored on a same wordline of memory device 130. In other embodiments, first level codeword 215 and additional parity codeword 230 are stored on different wordlines of memory device 130.

User data decoding component 113 reads user data first level codeword 215 from memory device 130. For example, user data decoding component 113 reads user data first level codeword 215 from memory device 130 in response to the memory subsystem receiving a request for user data 205 from a host system (e.g., host system 120 of FIG. 1). User data decoding component 113 attempts to decode user data first level codeword 215 to retrieve user data 205. For example, user data decoding component 113 runs an LDPC decoding algorithm on user data first level codeword 215 to correct any errors in user data 205 using first level parity data 210. In some embodiments, user data 205 has two levels of parity data associated with it. For example, user data 205 has first level parity data 210 stored alongside user data 205 (e.g., in user data first level codeword 215) and second level parity data 235 stored in a different location (e.g., in additional parity codeword 230).

If user data decoding component 113 fails to decode user data first level codeword 215, user data decoding component 113 reads additional parity codeword 230 from memory device 130. User data decoding component 113 can perform a hard read or a soft read on additional parity codeword 230. In some embodiments, user data decoding component 113 attempts to decode additional parity codeword 230 to retrieve second level parities 220 including the second level parity data 235 for user data 205. For example, user data decoding component 113 runs an LDPC decoding algorithm on additional parity codeword 230 to correct any errors in second level parities 220 using first level parity data 225. If user data decoding component 113 successfully decodes additional parity codeword 230 (e.g., by correcting all bit errors on additional parity codeword 230), user data decoding component 113 can obtain second level parity data 235 for user data 205 from the decoded second level parities 220 that is error free.

In some embodiments, user data decoding component 113 generates user data second level codeword 240 using user data 205, first level parity data 210, and second level parity data 235. For example, user data second level codeword 240 is a codeword with two levels of parity data (e.g., first level parity data 210 and second level parity data 235) such that when decoding user data second level codeword 240, user data decoding component 113 satisfies parity checks for both first level parity data 210 and second level parity data 235, thereby providing a higher error correction capability (e.g., the ability to correct more errors). The added level of parity data (e.g., second level parity data 235) allows user data decoding component 113 to decode more errors in user data 205 than would otherwise be possible with only first level parity data 210.

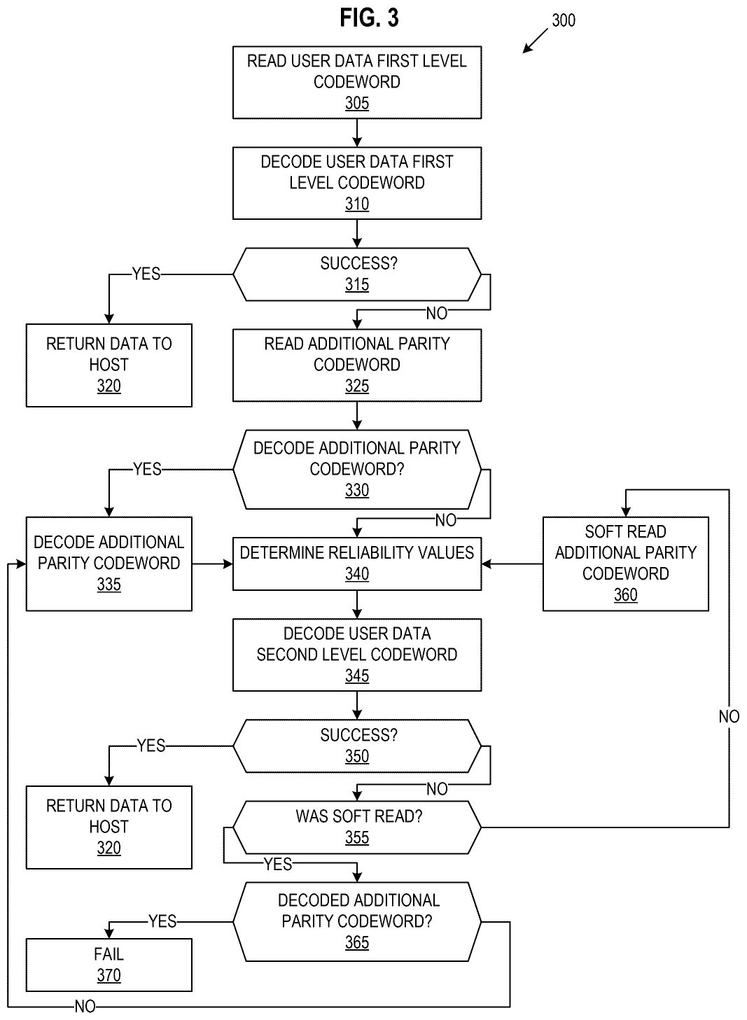

User data decoding component 113 selects reliability values for use in decoding user data second level codeword 240 based on one or more of: hard read information for additional parity codeword 230, soft read information for additional parity codeword 230, whether additional parity codeword 230 was decoded, the results of decoding additional parity codeword 230, and soft read information for user data first level codeword 215. Further details regarding reliability values are described with reference to FIG. 3.

User data decoding component 113 attempts to decode user data second level codeword 240 using the selected reliability values. For example, user data decoding component 113 runs an LDPC decoding algorithm on user data second level codeword 240 using the selected reliability values and updating the reliability values through iterations of the LDPC decoding algorithm to attempt to decode user data second level codeword 240 and retrieve user data 205. Further details with regard to decoding user data second level codeword 240 are described with reference to FIG. 3.

FIG. 3 is a flow diagram of an example method 300 to decode user data using reliability values, in accordance with some embodiments of the present disclosure. The method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300 is performed by the user data decoding component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 305, the processing device reads a user data first level codeword. For example, user data decoding component 113 reads a user data first level codeword (e.g., user data first level codeword 215 of FIG. 2) stored in a memory device (e.g., memory device 130 of FIG. 1). In some embodiments, user data decoding component 113 reads the user data first level codeword in response to a host command. For example, memory subsystem 110 receives a command from host system 120 to read user data (e.g., user data 205 of FIG. 2). In response to memory subsystem 110 receiving the command to read user data, user data decoding component 113 reads the user data first level codeword. In some embodiments, the user data first level codeword includes user data and first level parity data (e.g., first level parity data 210 of FIG. 2) for the user data. For example, the user data first level codeword is a codeword generated by applying an LDPC encoder to the user data to generate an LDPC codeword (e.g., user data codeword) including the user data and first level parity data for the user data.

In some embodiments, the processing device performs a soft read on the user data first level codeword and generates soft read information for the user data first level codeword. A soft read is a memory operation that produces soft read information including more than a single value for a bit of information. For example, performing a hard read on a bit of data uses a threshold voltage and yields a single bit of information (e.g., 0 or 1) per memory location based on whether an applied threshold voltage is greater than the cell voltage for the bit of data. In contrast, performing a soft read uses multiple threshold voltages and yields information about the value of the cell voltage compared to each of the applied threshold voltages. For example, for an SLC memory cell, the processing device can apply two threshold voltages, one below the midpoint of high and low voltage levels and one above the midpoint of high and low voltage levels. Using multiple voltage levels enables the processing device to differentiate between bits that read as strongly or confidently at a high or low voltage level as compared to those that read near the midpoint voltage level and, therefore, are more likely to be erroneous. Performing a soft read versus a hard read can increase the likelihood of success during decoding but consumes more time and power than a hard read. In some embodiments, the processing device uses the soft read information for the user data first level codeword when attempting to decode the user data first level codeword. For example, user data decoding component 113 uses the soft read information to select reliability values for the user data first level codeword during decoding (e.g., operations 310 and/or 345).

At operation 310, the processing device decodes the user data first level codeword. For example, user data decoding component 113 applies an LDPC decoding algorithm to the user data first level codeword to retrieve the user data. In some embodiments, the processing device performs a decode operation on the user data first level codeword by attempting to correct the bit errors. For example, in response to detecting errors in the user data first level codeword, user data decoding component 113 can use the soft read information to iteratively update the reliability values based on the parity check constraints and reliability values on the parity check. At each iteration, the processing device makes decisions about which bits are most likely to be in error using the reliability values. The processing device continues the decoding process until the decoder converges to a solution (e.g., no parity violations remaining), or until a maximum number of iterations is reached.

In some embodiments, user data decoding component 113 can use the reliability values for LDPC decoders in different ways. For example, user data decoding component 113 can use the LLRs to determine the order in which to update the bits in the codeword, calculate the probability that a bit is in error, estimate the channel noise level, and/or adapt the decoding algorithm to the memory conditions.

At operation 315, the processing device determines whether decoding the user data first level codeword was successful. For example, user data decoding component 113 determines whether the LDPC decoding algorithm decoded the user data or whether the LDPC decoding algorithm failed to decode the user data. In some embodiments, the processing device determines that decoding the user data was not successful if the decoding algorithm timed out without converging on a solution. Similarly, in some embodiments, the processing device determines that decoding the user data was successful if the decoding algorithm converged onto a solution.

In some embodiments, the decoding algorithm fails because there are too many errors in the codeword. For example, if the number of bits in error is greater than the number of bits able to be protected by the first level parity data, the processing device determines that decoding the user data first level codeword was not successful. In some embodiments, user data decoding component 113 performs a soft read operation on user data first level codeword in response to failing to decode user data first level codeword. For example, if a hard read operation was performed on user data first level codeword and the processing device determines that decoding the user data first level codeword was not successful, the method 300 returns to operation 305 and the processing device performs a soft read operation on user data first level codeword to obtain soft read information for user data first level codeword. In some embodiments, the processing device attempts to decode user data first level codeword with the soft read information. If the processing device determines that decoding the user data first level codeword was successful, the method 300 proceeds to operation 320. If the processing device determines that decoding the user data first level codeword was not successful, the method 300 proceeds to operation 325. In some embodiments, the processing device determining that decoding the user data first level codeword was not successful and proceeding to operation 325 indicates that the errors on user data first level codeword cannot be corrected by the first level parity data.

At operation 320, the processing device returns the decoded user data to the host. For example, user data decoding component 113 sends the decoded user data (e.g., user data 205 of FIG. 2) to a host system (e.g., host system 120 of FIG. 1). In some embodiments, user data decoding component 113 sends the decoded user data to a host system in response to a memory command (e.g., a read command sent by host system 120 to memory subsystem 110).

At operation 325, the processing device reads an additional parity codeword. For example, user data decoding component 113 reads an additional parity codeword (e.g., additional parity codeword 230 of FIG. 2) associated with the user data from a memory device (e.g., memory device 130 of FIG. 1). In some embodiments, the additional parity codeword is stored separate from the user data codeword. For example, the additional parity codeword is stored in a separate portion of memory device 130. In some embodiments, the additional parity codeword includes second level parity data for the user data (e.g., second level parity data 235). For example, the second level parity data can include parity data that, when used in combination with first level parity data, enables user data decoding component 113 to correct a greater number of errors than the first level parity data alone.

In some embodiments, the additional parity codeword includes parity information from multiple portions of memory (e.g., including portions of memory other than the portion of memory where the user data is stored). For example, the additional parity codeword includes second level parity information (e.g., second level parities 220) for multiple pages (including a page containing the user data codeword) and its own parity information to form a codeword to increase the reliability of reading the second level parity information. For example, the second level parities are encoded using an LDPC encoding algorithm and stored with first level parity data (e.g., first level parity data 225) for the second level parities.

In some embodiments, the processing device performs a hard read on the additional parity codeword. For example, as explained above, user data decoding component 113 applies threshold voltages to determine a value of a memory cell storing the additional parity codeword. In one example, where the memory cell including the additional parity codeword is an SLC, user data decoding component 113 applies a threshold voltage and determines the hard read information based on whether the cell voltage is greater than the threshold voltage. It should be appreciated that performing a hard read on memory cells with more than one bit (e.g., MLCs, TLCs, QLCs, and PLCs) will use more than one threshold voltage to obtain the hard read information.

In some embodiments, the processing device performs a soft read on the additional parity codeword. For example, as explained above, user data decoding component 113 applies threshold voltages to determine a level of confidence in the values of a memory cell storing the additional parity codeword as described above.

At operation 330, the processing device determines whether to decode the additional parity codeword. For example, user data decoding component 113 determines whether to perform an LDPC decoding operation on the additional parity codeword read from memory to attempt to correct any bits that may be in error. In some embodiments, the processing device determines whether to decode the additional parity codeword based on whether the current attempt to decode the user data is the first attempt using the second level parity data. In some embodiments, the processing device does not decode the additional parity codeword when trying to decode the user data using the second level parity data for the first time but does decode the additional parity codeword on subsequent attempts. In some embodiments, the processing device is configured to always decode the additional parity codeword. If the processing device determines to decode the additional parity codeword, the method 300 proceeds to operation 335. If the processing device determines not to decode the additional parity codeword, the method 300 proceeds to operation 340.

At operation 335, the processing device decodes the additional parity codeword. For example, user data decoding component 113 applies an LDPC decoding algorithm to the additional parity codeword by attempting to correct bit errors in the second level parities based on the parity data for the second level parities as explained above with reference to the user data codeword.

At operation 340, the processing device determines reliability values for decoding the user data using both the first level parity data and second level parity data. For example, user data decoding component 113 determines reliability values for the user data first level codeword (user data and first level parity data) and the second level parity data (read from the additional parity codeword) to use while decoding the user data (as illustrated by user data second level codeword 240). In some embodiments, the reliability values differ based on one or more of: hard read information for the additional parity codeword, soft read information for the additional parity codeword, whether the additional parity codeword was successfully decoded, the results of decoding the additional parity codeword, and the soft read information for the user data first level codeword. For example, the processing device selects a first set of reliability values for the second level parity data (read from the additional parity codeword) if the processing device performed a hard read on the additional parity codeword and the processing device did not decode the additional parity codeword or failed to decode the additional parity codeword. The processing device selects a second set of reliability values for the second level parity data if the processing device performed a soft read on the additional parity codeword and the processing device did not decode the additional parity codeword or failed to decode the additional parity codeword. The processing device selects a third set of reliability values if the processing device successfully decoded the additional parity codeword (regardless of whether the processing device performed a hard or soft read).

In some embodiments, the reliability values are predetermined and stored in the memory subsystem. For example, the reliability values are set by performing stress tests on known wordlines that are weak, collecting the threshold voltage information from those stress tests, and running mutual information analysis to determine likelihood values for different wordlines (e.g., weak versus typical).

In one embodiment, user data decoding component 113 sets the reliability values for the second level parity data to a maximum reliability value if user data decoding component 113 successfully decodes the additional parity codeword. For example, if user data decoding component 113 runs an LDPC decoding algorithm on the additional parity codeword and the LDPC algorithm converges on a result, user data decoding component 113 can determine the correct values for second level parity from the result. User data decoding component 113 therefore sets the reliability for the second level parity (for decoding user data second level codeword) to a maximum since it knows the values are accurate.

In some embodiments, user data decoding component 113 freezes the reliability values for the second level parity data if user data decoding component 113 successfully decodes the additional parity codeword. For example, user data decoding component 113 freezes the reliability values for the second level parity data to prevent the second level parity bits from being changed during the decoding of the user data (e.g., during operation 345).

In some embodiments, user data decoding component 113 freezes the second level parity if user data decoding component 113 successfully decodes the additional parity codeword. For example, if user data decoding component 113 runs an LDPC decoding algorithm on the additional parity codeword and the LDPC algorithm converges on a result, user data decoding component 113 can determine the correct values for second level parity from the result. User data decoding component 113 therefore freezes the bits of the second level parity to prevent any changing of those bits during the decoding of the user data (e.g., during operation 345).

At operation 345, the processing device decodes the user data second level codeword using the reliability values. For example, user data decoding component 113 applies an LDPC decoding algorithm using the user data first level codeword and the second level parity data from the additional parity codeword as well as the determined reliability values to retrieve the user data. The processing device decodes the user data second level codeword (e.g., user data second level codeword 240 of FIG. 2) by attempting to correct the bit errors in the codeword using the first level parity data and the second level parity data as well as the reliability values. For example, in response to detecting bit errors in the user data, the first level parity data, and/or the second level parity data, user data decoding component 113 can use reliability values (e.g., soft read information) determined for each of the user data and first level parity data and the second level parity data and iteratively update the reliability values based on the parity check constraints. At each iteration, the processing device makes decisions about which bits are most likely to be in error using the reliability values. The processing device continues the decoding process until the decoder converges to a solution, or until a maximum number of iterations/time is reached.

In some embodiments, user data decoding component 113 applies a scalar and/or offset when updating the reliability values. For example, user data decoding component 113 determines the scalar based on hard read information for the additional parity codeword, soft read information for the additional parity codeword, whether the additional parity codeword was decoded, the results of decoding the additional parity codeword, and the soft read information for the user data first level codeword. User data decoding component 113 then applies the scalar while updating the reliability values to amplify or dampen the change in the reliability values. For example, the processing device selects a first scalar for the second level parity data (read from the additional parity codeword) if the processing device performed a hard read on the additional parity codeword and the processing device did not decode the additional parity codeword or failed to decode the additional parity codeword. The processing device selects a second scalar for the second level parity data if the processing device performed a soft read on the additional parity codeword and the processing device did not decode the additional parity codeword or failed to decode the additional parity codeword. The processing device selects a third scalar if the processing device successfully decoded the additional parity codeword (regardless of whether the processing device performed a hard or soft read). User data decoding component 113 uses the selected scalar while updating the reliability values. For example, a smaller scalar will dampen changes to the reliability values while a larger scalar will amplify changes to the reliability values.

At operation 350, the processing device determines whether decoding the user data second level codeword was successful. For example, user data decoding component 113 determines whether the LDPC decoding algorithm decoded the user data second level codeword or whether the LDPC decoding algorithm failed to decode the user data second level codeword. In some embodiments, the processing device determines that decoding the user data second level codeword was not successful if the decoding algorithm timed out without converging on a solution. Similarly, in some embodiments, the processing device determines that decoding the user data second level codeword was successful if the decoding algorithm converged onto a solution.

In some embodiments, the decoding algorithm fails because there are too many errors in the codeword. For example, if the number of bits in error is greater than the number of bits able to be corrected by the first level parity data and the second level parity data, the processing device determines that decoding the user data second level codeword was not successful. If the processing device determines that decoding the user data second level codeword was successful, the method 300 proceeds to operation 320. If the processing device determines that decoding the user data second level codeword was not successful, the method 300 proceeds to operation 355.

At operation 355, the processing device determines whether a soft read was performed on the additional parity codeword. For example, user data decoding component 113 determines whether a soft read was performed on the additional parity codeword (e.g., during operation 325). If the processing device determines that a soft read was performed on the additional parity codeword, the method 300 proceeds to operation 365. If the processing device determines that a soft read was not performed on the additional parity codeword, the method 300 proceeds to operation 360.

At operation 360, the processing device performs a soft read on the additional parity codeword. For example, user data decoding component 113 performs a soft read on the additional parity codeword and retrieves soft read information regarding the additional parity codeword as explained with reference to operation 325. The method 300 proceeds to operation 340 and processing device uses the retrieved soft read information to determine updated reliability values.

At operation 365, the processing device determines whether the additional parity codeword was decoded. For example, user data decoding component 113 determines whether the additional parity codeword was attempted to be decoded (e.g., during operation 335). If the processing device determines that the additional parity codeword was decoded, the method 300 proceeds to operation 370. If the processing device determines that the additional parity codeword was not decoded, the method 300 proceeds to operation 335 to decode the additional parity codeword. The method 300 further proceeds to operation 340 and processing device uses the results of decoding the additional parity codeword (e.g., whether or not the decoding was successful) to determine updated reliability values.

At operation 370, the processing device determines that there was a failure to decode the user data. For example, user data decoding component 113 determines that there was a failure to decode the user data for both the first level parity and the second level parity. In some embodiments, the processing device proceeds with another error correcting mechanism. For example, user data decoding component 113 can use methods for more involved scans and/or reads of the user data codeword and the additional parity codeword.

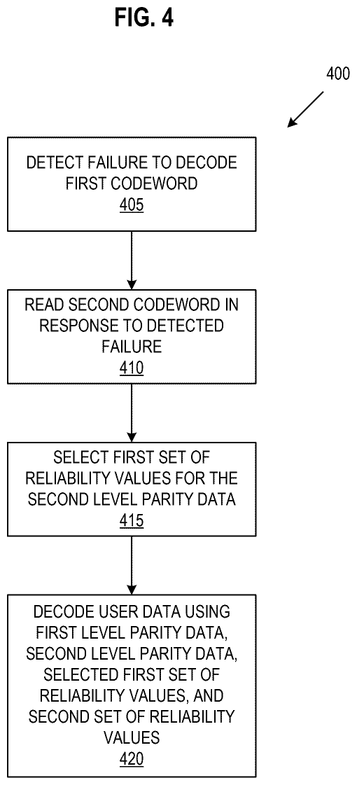

FIG. 4 is a flow diagram of an example method 400 to decode user data using reliability values, in accordance with some embodiments of the present disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by the user data decoding component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 405, the processing device detects a failure to decode a first codeword. For example, memory subsystem 110 receives a memory command from host system 120 which causes user data decoding component 113 to attempt to decode user data first level codeword 215 including user data 205 requested in the memory command from host system 120 and first level parity data 210. User data decoding component 113 attempts to decode user data first level codeword 215 and determines that decoding the user data first level codeword 215 was not successful if the decoding algorithm timed out without converging on a solution. Further details with regard to failing to decode a first codeword are discussed with reference to FIG. 3.

At operation 410, the processing device reads a second codeword in response to the detected failure. For example, user data decoding component 113 reads additional parity codeword 230 from memory device 130 in response to failing to decode user data first level codeword 215. In some embodiments, user data decoding component 113 performs a soft read on additional parity codeword 230 and determines soft read information from the soft read. In other embodiments, user data decoding component 113 performs a hard read on additional parity codeword 230. Further details with regard to reading a second codeword are discussed with reference to FIG. 3.

At operation 415, the processing device selects a first set of reliability values for the second level parity. For example, user data decoding component 113 selects reliability values to use in decoding user data second level codeword 240 based on one or more of: hard read information for the additional parity codeword 230, soft read information for the additional parity codeword 230, whether the additional parity codeword 230 was successfully decoded, the results of decoding the additional parity codeword 230, and the soft read information for the user data first level codeword 215. In some embodiments, the processing device selects the first set of reliability values for additional parity codeword 230. For example, user data decoding component 113 selects a first option for the first set of reliability values if user data decoding component 113 performed a hard read on additional parity codeword 230 and user data decoding component 113 did not decode additional parity codeword 230 or failed to decode additional parity codeword 230. The processing device selects a second option for the first set of reliability values if user data decoding component 113 performed a soft read on additional parity codeword 230 and user data decoding component 113 did not decode additional parity codeword 230 or failed to decode additional parity codeword 230. User data decoding component 113 selects a third option for the first set of reliability values if user data decoding component 113 successfully decoded additional parity codeword additional parity codeword 230 (regardless of whether user data decoding component 113 performed a hard or soft read). Further details with regard to selecting a first set of reliability values are discussed with reference to FIG. 3.

At operation 420, the processing device decodes the user data using the first level parity data, the second level parity data, the selected first set of reliability values and the second set of reliability values. For example, user data decoding component 113 runs and LDPC decoding algorithm on user data second level codeword 240 to retrieve user data 205 using the selected reliability values. User data decoding component 113 updates the reliability values at each iteration of the decoding algorithm until the decoding algorithm converges on a solution. Further details with regard to decoding the user data are described with reference to FIG. 3.

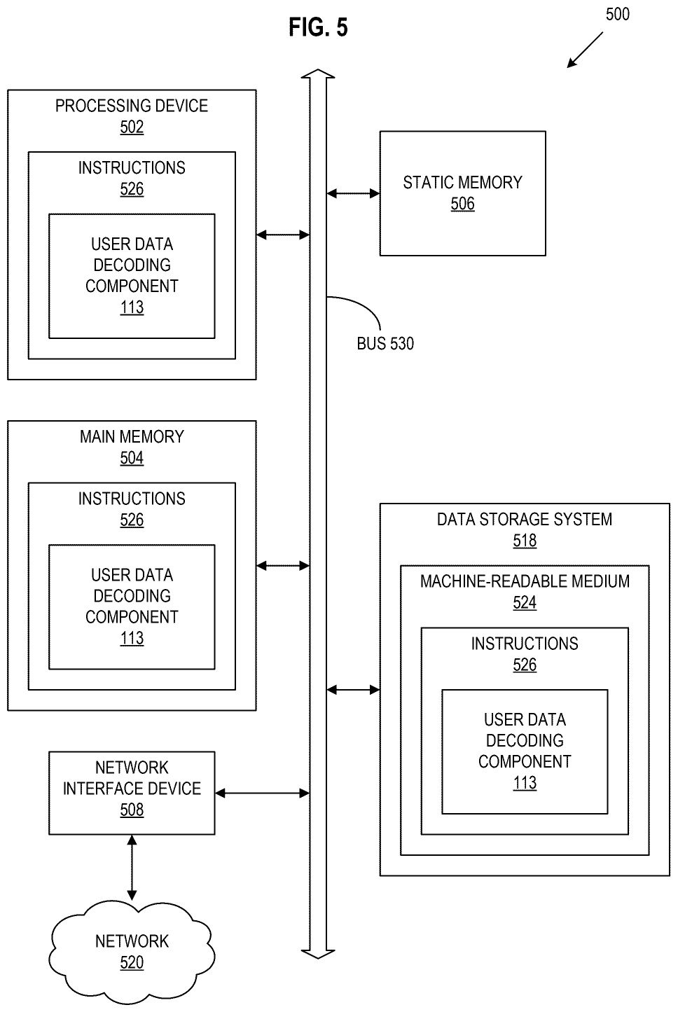

FIG. 5 illustrates an example machine of a computer system 500 within which a set of instructions for causing the machine to perform any one or more of the methodologies discussed herein can be executed. In some embodiments, the computer system 500 can correspond to a host system (e.g., the host system 120 of FIG. 1) that includes, is coupled to, or utilizes a memory subsystem (e.g., the memory subsystem 110 of FIG. 1) or can be used to perform the operations of a controller (e.g., to execute an operating system to perform operations corresponding to the user data decoding component 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a smart device, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., read-only memory (ROM), flash memory, dynamic random-access memory (DRAM) such as synchronous DRAM (SDRAM) or Rambus DRAM (RDRAM), etc.), a static memory 506 (e.g., flash memory, static random-access memory (SRAM), etc.), and a data storage system 518, which communicate with each other via a bus 530.

Processing device 502 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, a processor implementing other instruction sets, or processors implementing a combination of instruction sets. Processing device 502 can also be one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein. The computer system 500 can further include a network interface device 508 to communicate over the network 520.

The data storage system 518 can include a machine-readable storage medium 524 (also known as a computer-readable medium) on which is stored one or more sets of instructions 526 or software embodying any one or more of the methodologies or functions described herein. The instructions 526, constituting machine-readable storage media, can also reside, completely or at least partially, within the main memory 504 and/or within the processing device 502 during execution thereof by the computer system 500, the main memory 504 and the processing device 502. The machine-readable storage medium 524, data storage system 518, and/or main memory 504 can correspond to the memory subsystem 10 of FIG. 1.

In one embodiment, the instructions 526 include instructions to implement functionality corresponding to a user data decoding component (e.g., user data decoding component 113 of FIG. 1). While the machine-readable storage medium 524 is shown in an example embodiment to be a single medium, the term “machine-readable storage medium” should be taken to include a single medium or multiple media that store the one or more sets of instructions (e.g., instructions 526). The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system, such as the controller 115, may carry out the computer-implemented methods 300 and 400 in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random-access memories (RAMs), EPROMs, EEPROMs, magnetic or optical cards, or any type of media suitable for storing electronic instructions coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method comprising:
detecting a failure to decode a first codeword, the first codeword including user data and first level parity data for the user data;
reading a second codeword in response to the detected failure, the second codeword including second level parity data for the user data;
selecting a first set of one or more reliability values for the second level parity data, the first set of reliability values differing from a second set of reliability values for the user data and the first level parity data; and
decoding the user data using the first level parity data, the second level parity data, the selected first set of reliability values, and the second set of reliability values.

2. The method of claim 1, further comprising:
decoding the second codeword, wherein selecting the first set of one or more reliability values uses a result of decoding the second codeword.

3. The method of claim 2, further comprising:
selecting the first set of one or more reliability values as a maximum reliability value in response to successfully decoding the second codeword.

4. The method of claim 2, further comprising:
freezing the second codeword to prevent bits of the second codeword from changing during the decoding of the user data in response to successfully decoding the second codeword.

5. The method of claim 1, further comprising:
detecting a failure to decode the user data using the second level parity data;
decoding the second codeword in response to the detected the failure to decode the user data;
selecting a third set of one or more reliability values for the second level parity data in response to successfully decoding the second codeword, the third set of one or more reliability values differing from the first set of reliability values and the second set of reliability values; and
decoding the user data using the first level parity data, the second level parity data, the selected third set of reliability values, and the second set of reliability values.

6. The method of claim 1, wherein reading the second codeword comprises performing a hard read on the second codeword, the method further comprising:
detecting a failure to decode the user data using the second level parity data;
obtaining soft read information by performing a soft read on the second codeword in response to the detected the failure to decode the user data, wherein selecting the first set of one or more reliability values for the second level parity data uses the soft read information; and
decoding the user data using the first level parity data, the second level parity data, the selected first set of reliability values, and the second set of reliability values.

7. The method of claim 1, further comprising:
selecting a first reliability scalar for the second level parity data;
selecting a second reliability scalar for the user data and the first level parity data, the first reliability scalar differing from the second reliability scalar; and
wherein decoding the user data comprises updating the first set of one or more reliability values using the first reliability scalar and updating the second set of one or more reliability values using the second reliability scalar.

8. A non-transitory computer-readable storage medium comprising instructions that, when executed by a processing device, cause the processing device to:
detect a failure to decode a first codeword, the first codeword including user data and first level parity data for the user data;
read a second codeword in response to the detected failure, the second codeword including second level parity data for the user data;
select a first set of one or more reliability values for the second level parity data, the first set of reliability values differing from a second set of reliability values for the user data and the first level parity data; and
decode the user data using the first level parity data, the second level parity data, the selected first set of reliability values, and the second set of reliability values.

9. The non-transitory computer-readable storage medium of claim 8, wherein the processing device is further to:
decode the second codeword, wherein selecting the first set of one or more reliability values uses a result of decoding the second codeword.

10. The non-transitory computer-readable storage medium of claim 9, wherein the processing device is further to:
select the first set of one or more reliability values as a maximum reliability value in response to successfully decoding the second codeword.

11. The non-transitory computer-readable storage medium of claim 9, wherein the processing device is further to:
freeze the second codeword to prevent bits of the second codeword from changing during the decoding of the user data in response to successfully decoding the second codeword.

12. The non-transitory computer-readable storage medium of claim 8, wherein the processing device is further to:
detect a failure to decode the user data using the second level parity data;
decode the second codeword in response to the detected the failure to decode the user data;
select a third set of one or more reliability values for the second level parity data in response to successfully decoding the second codeword, the third set of one or more reliability values differing from the first set of reliability values and the second set of reliability values; and
decode the user data using the first level parity data, the second level parity data, the selected third set of reliability values, and the second set of reliability values.

13. The non-transitory computer-readable storage medium of claim 8, wherein reading the second codeword comprises performing a hard read on the second codeword and wherein the processing device is further to:
detect a failure to decode the user data using the second level parity data;
obtain soft read information by performing a soft read on the second codeword in response to the detected the failure to decode the user data, wherein selecting the first set of one or more reliability values for the second level parity data uses the soft read information; and
decode the user data using the first level parity data, the second level parity data, the selected first set of reliability values, and the second set of reliability values.

14. The non-transitory computer-readable storage medium of claim 8, wherein the processing device is further to:
select a first reliability scalar for the second level parity data;
select a second reliability scalar for the user data and the first level parity data, the first reliability scalar differing from the second reliability scalar; and
wherein decoding the user data comprises updating the first set of one or more reliability values using the first reliability scalar and updating the second set of one or more reliability values using the second reliability scalar.

15. A system comprising:
a plurality of memory devices; and
a processing device, operatively coupled with the plurality of memory devices, to:
detect a failure to decode a first codeword, the first codeword including user data and first level parity data for the user data;
read a second codeword in response to the detected failure, the second codeword including second level parity data for the user data;
decode the second codeword;
select a first set of one or more reliability values for the second level parity data using a result of decoding the second codeword, the first set of reliability values differing from a second set of reliability values for the user data and the first level parity data; and
decode the user data using the first level parity data, the second level parity data, the selected first set of reliability values, and the second set of reliability values.

16. The system of claim 15, wherein the processing device is further to:
select the first set of one or more reliability values as a maximum reliability value in response to successfully decoding the second codeword.

17. The system of claim 15, wherein the processing device is further to:
freeze the second codeword to prevent bits of the second codeword from changing during the decoding of the user data in response to successfully decoding the second codeword.

18. The system of claim 15, wherein the processing device is further to:
detect a failure to decode the user data using the second level parity data, wherein decoding the second codeword is in response to the detected the failure to decode the user data;
select a third set of one or more reliability values for the second level parity data in response to successfully decoding the second codeword, the third set of one or more reliability values differing from the first set of reliability values and the second set of reliability values; and
decode the user data using the first level parity data, the second level parity data, the selected third set of reliability values, and the second set of reliability values.

19. The system of claim 15, wherein reading the second codeword comprises performing a hard read on the second codeword and wherein the processing device is further to:
detect a failure to decode the user data using the second level parity data;
obtain soft read information by performing a soft read on the second codeword in response to the detected the failure to decode the user data, wherein selecting the first set of one or more reliability values for the second level parity data uses the soft read information; and
decode the user data using the first level parity data, the second level parity data, the selected first set of reliability values, and the second set of reliability values.

20. The system of claim 15, wherein the processing device is further to:
select a first reliability scalar for the second level parity data;
select a second reliability scalar for the user data and the first level parity data, the first reliability scalar differing from the second reliability scalar; and
wherein decoding the user data comprises updating the first set of one or more reliability values using the first reliability scalar and updating the second set of one or more reliability values using the second reliability scalar.
